(19) United States
(12) Patent Application Publication
(10) Pub. No.: US 2008/0133838 A1
(43) Pub. Date: Jun. 5, 2008

(54) Data processing device

(76) Inventors: Kotaro Higuchi, Osaka (JP); Shinya Miyaji, Nara (JP)

Correspondence Address: MCDERMOTT WILL & EMERY LLP, 600 13TH STREET, NW, WASHINGTON, DC, 20005-3096, US

(21) Appl. No.: 11/878,198

(22) Filed: Jul. 23, 2007

(30) Foreign Application Priority Data
Dec. 1, 2006 (JP) 2006-325565

(51) Int. Cl. G06F 13/00

(52) U.S. Cl. 711/125

(57) ABSTRACT

In a data processing device including a main memory for storing therein a plurality of instruction streams and a processor for executing an instruction stream transferred from the main memory, the processor includes: an instruction RAM for storing therein the instruction stream transferred from the main memory; a location address setting section for setting location addresses on a memory space at which the instruction RAM will be placed; and an instruction fetch control section for determining, based on the location addresses set by the location address setting section, a space to be accessed by an instruction fetch access, and, according to result of the determination, making access to either the main memory or the instruction RAM. The location address setting section sets the location addresses in such a manner that location addresses, on the memory space, of the instruction stream stored in the instruction RAM do not coincide with location addresses, on the instruction RAM, of another instruction stream.

### CROSS-REFERENCE TO RELATED APPLICATION

The disclosure of Japanese Patent Application No. 2006-325565 filed on Dec. 1, 2006 including specification, drawings and claims is incorporated herein by reference in its entirety.

### BACKGROUND OF THE INVENTION

1. Field of the Invention

The present invention relates to a data processing device including a processor which transfers an instruction stream stored in a flash memory or the like to a RAM (random access memory) to execute the instructions.

2. Description of the Related Art

Some processors, such as microcomputers, are configured so as to include a main memory, such as a ROM (read only memory), and a RAM (hereinafter referred to as an “instruction RAM”), which is a relatively high-speed, small-capacity memory as compared with the main memory and so as to transfer, as necessary, a program stored in the main memory to the instruction RAM in instruction-stream units to execute the program. The processors thus configured can execute a program whose size is not limited by the capacity of the instruction RAM, on the instruction RAM capable of high-speed operation, and hence can increase the processing performance thereof (this technique is sometimes called overlay technique).

As shown in FIG. 11, for example, in a processor having the above-described configuration, at an address A on the instruction RAM, an instruction C1 in an instruction stream P1 is stored at a time T1, and an instruction C2 in an instruction stream P2 is stored at a time T2.

When a program, executed by a processor such as a microcomputer, is debugged, a method, in which a breakpoint is established to stop the execution of the program, is typically used. In this method, for example, the address of an instruction whose execution is to be stopped is set in a certain register in the debug device, and the address set in the register is compared with the address of each instruction to be executed by the processor, and when these addresses match each other, an interrupt signal is produced to stop the execution of the instruction.

However, when this conventional debugging method is applied to a processor employing the overlay technique, it is difficult to debug a plurality of instruction streams. This is because even if, for an instruction stream transferred to the instruction RAM, the address of an instruction whose execution is to be stopped is set in a register, the set address becomes meaningless, when the next instruction stream is transferred to the instruction RAM.

Suppose, for example, a case in which, as shown in FIG. 11, a break is made to occur in the instruction C1 (stored at the address A) in the instruction stream P1 stored in the instruction RAM. In this case, the address A is set in the register as the breakpoint, and when the value of the program counter (PC) matches the set breakpoint (the address A), the break occurs.

However, if the instruction stream P2 is executed before the instruction stream P1, the instruction C1 at the address A is replaced with the instruction C2, which causes the break to occur in the instruction C2 in the instruction stream P2. That is, the break occurs improperly at the unintended location.

To overcome this, a technique has been disclosed (in Japanese Laid-Open Publication No. 2003-345624, for example), in which a plurality of program codes identified by identifiers are used; an instruction RAM, where one of the program codes that is to be executed is stored, and a variable area, where the identifier of the program code stored in the instruction RAM is stored, are provided; and when the contents in the instruction RAM match the contents in the variable area, a break is made to occurs.

Nevertheless, a processor using identifiers in the above-described manner has the following problem.

First, in a case in which a memory area for retaining identification information is implemented in hardware, not only the hardware is increased by the memory area, but also logic for checking the identification information about the instruction stream on the RAM has to be added to comparison logic for comparing the program counter (PC) and a breakpoint. Thus, the hardware is caused to increase further.

Moreover, software processing for controlling the identification information becomes necessary, resulting in an increase in processing time.

### SUMMARY OF THE INVENTION

The present invention was made in view of the foregoing problems, and it is therefore an object of the present invention to allow program debugging to be performed using a conventional debug device and debugger, while suppressing increases in hardware.

In order to achieve the object, an inventive data processing device includes a main memory for storing therein a plurality of instruction streams and a processor for executing an instruction stream transferred from the main memory, wherein the processor includes: an instruction RAM for storing therein the instruction stream transferred from the main memory; a location address setting section for setting location addresses on a memory space at which the instruction RAM will be placed in such a manner that location addresses, on the memory space, of the instruction stream stored in the instruction RAM do not coincide with location addresses, on the instruction RAM, of another instruction stream; and an instruction fetch control section for determining, based on location address information indicating the location addresses set by the location address setting section, a space to be accessed by an instruction fetch access, and, according to result of the determination, making access to either the main memory or the instruction RAM.

### BRIEF DESCRIPTION OF THE DRAWINGS

FIG. 1 is a block diagram illustrating the configuration of a data processing device 100 according to a first embodiment.

FIG. 2 is a block diagram schematically illustrating the configuration of a processor 120.

FIG. 3 is a flowchart for explaining operation of the data processing device 100.

FIG. 4 is a view showing the locations of instruction streams in the first embodiment.

FIG. 5 is a block diagram illustrating the configuration of a location address setting section 122 according to a modified example of the first embodiment.

FIG. 6 is a flowchart for explaining operation of a data processing device according to a second embodiment.

FIG. 7 is a view showing the locations of instruction streams in the second embodiment.

FIG. 8 is a block diagram illustrating the configuration of a location address setting section 122 according to a modified example of the second embodiment.

FIG. 9 is a block diagram schematically illustrating the configuration of a processor 200 according to a third embodiment.

FIG. 10 is a block diagram illustrating the configuration of a processor 300 according to a modified example of the third embodiment.

FIG. 11 is a view illustrating an example of the locations of instruction streams in a conventional data processing device.

### DETAILED DESCRIPTION OF THE INVENTION

Hereinafter, embodiments of the present invention will be described with reference to the accompanying drawings. In the following embodiments and the modified examples thereof, components having the same function as those already described are identified by the same reference numerals, and the description thereof will be omitted.

### First Embodiment

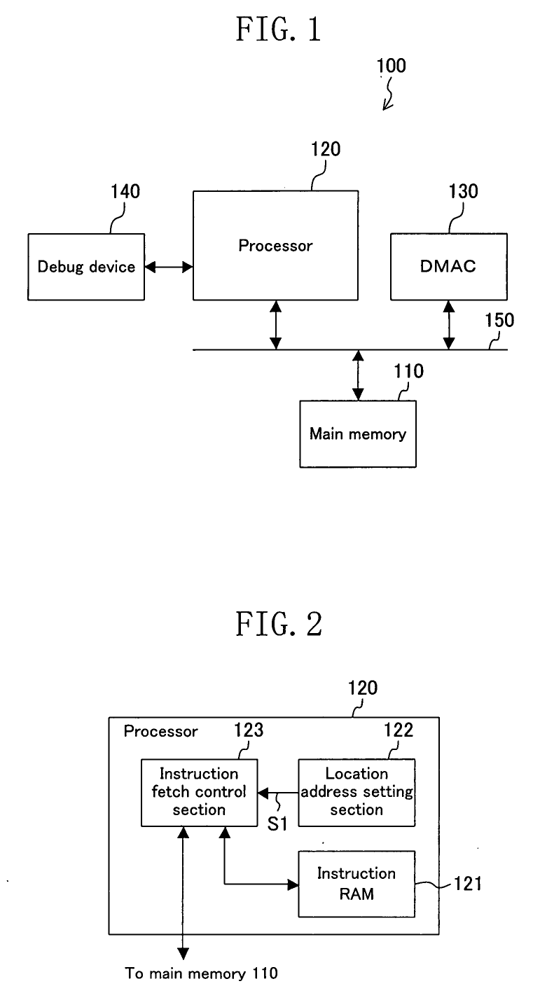

FIG. 1 is a block diagram illustrating the configuration of a data processing device 100 according to a first embodiment of the present invention. As shown in FIG. 1, the data processing device 100 includes a main memory 110, a processor 120, a DMA controller 130 (DMA is an abbreviation for “direct memory access”, and in FIG. 1, the DMA controller is abbreviated as DMAC (direct memory access controller)), and a debug device 140. The main memory 110, the processor 120, and the DMA controller 130 are connected through a bus 150.

The main memory 110 stores therein a plurality of instruction streams (programs). Specifically, the main memory 110 may be configured by a flash memory or the like.

The processor 120 executes each instruction in an instruction stream transferred from the main memory 110. FIG. 2 is a block diagram schematically illustrating the configuration of the processor 120. As shown in FIG. 2, the processor 120 includes an instruction RAM 121, a location address setting section 122, and an instruction fetch control section 123.

The instruction RAM 121 retains the instruction stream transferred from the main memory 110. To be specific, the instruction RAM 121 is configured by a relatively high-speed, small-capacity RAM as compared with the main memory 110.

The location address setting section 122 sets location addresses on the memory space at which the instruction RAM 121 will be placed. Specifically, in a sequence for transferring an instruction stream from the main memory 110 to the instruction RAM 121, the location address setting section 122 performs the step (Step ST001 that will be described later) of setting location addresses on the memory space for the instruction RAM 121 in such a manner that the addresses, on the instruction RAM 121, of the instruction stream to be transferred (i.e., the addresses at which the instruction stream will be executed) do not coincide with location addresses on the instruction RAM 121 at which another instruction stream will be placed.

Based on information (location address information S1) indicating the location addresses set by the location address setting section 122, the instruction fetch control section 123 determines a space to be accessed by an instruction fetch access. And according to the determination result, the instruction fetch control section 123 makes access to the memory to be accessed (herein the main memory 110 or the instruction RAM 121).

The DMA controller 130 controls data transfer between the main memory 110 and the instruction RAM 121.

The debug device 140 is connected with the processor 120 and debugs programs. Specifically, the debug device 140 includes a register, in which the address of an instruction whose execution is to be stopped is set, and compares, as one of the debugging functions thereof, the address set in the register with the address of each instruction to be executed by the processor 120. And when these addresses mach each other, the debug device 140 produces an interrupt signal to stop the execution of the instruction by the processor 120.

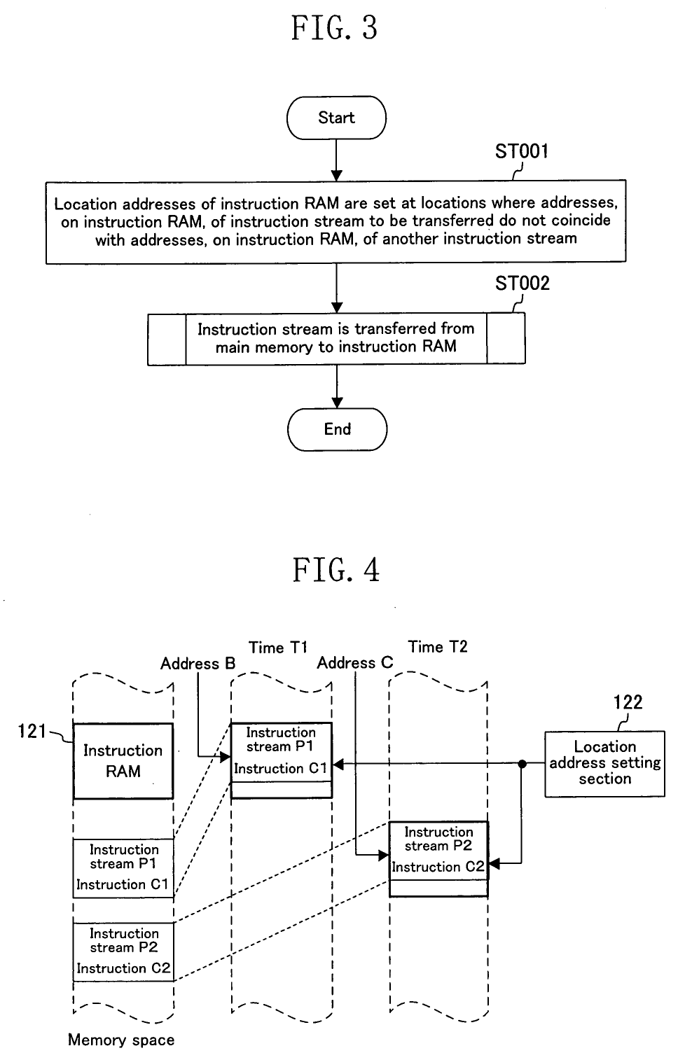

In an overlay process in which an instruction stream is transferred from the main memory 110 to the instruction RAM 121 for execution of the instruction stream, the data processing device 100 operates as shown in a flowchart in FIG. 3.

In Step ST001, the location address setting section 122 sets location addresses on the memory space at which the instruction RAM 121 will be placed in such a manner that the addresses, on the instruction RAM 121, of the instruction stream to be transferred (i.e., the addresses at which the instruction stream will be executed) do not coincide with the addresses, on the instruction RAM 121, of another instruction stream.

In Step ST002, the processor 120 controls the DMA controller 130 so that the instruction stream is placed in the memory to be accessed (i.e., the instruction RAM 121).

By this step, each instruction can be placed at a unique address as shown in FIG. 4, in which, for example, an instruction C1 in an instruction stream P1 is located at an address B, and an instruction C2 in an instruction stream P2 is located at an address C. In other words, in the data processing device 100, it is possible to prevent the instruction streams from being located at the same addresses, thereby allowing a breakpoint to be set accurately.

According to this embodiment, program debugging can thus be performed by using a conventional debug device and debugger, while increases in hardware are suppressed. Hence it becomes easy to develop programs in the processor using the overlay technique.

### Modified Example of the First Embodiment

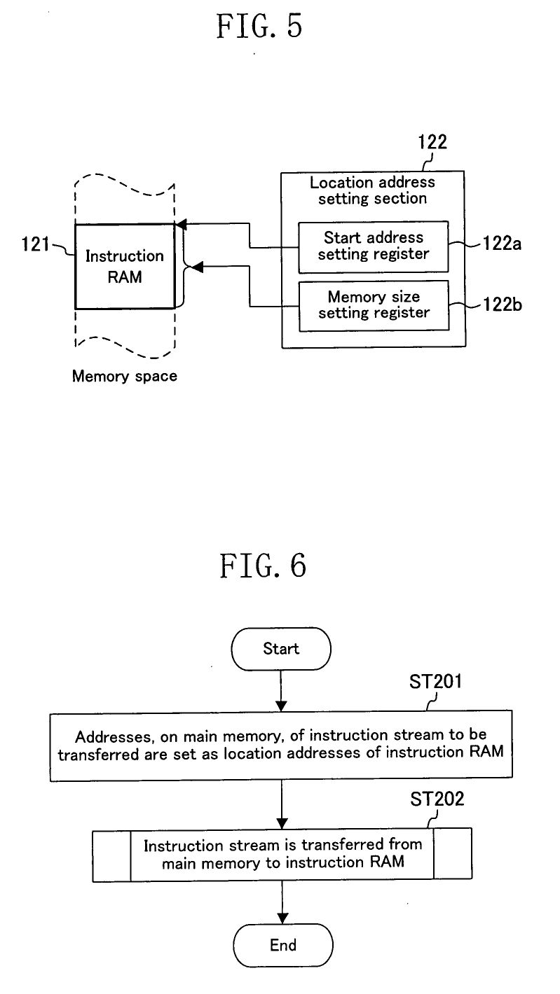

The location address setting section 122 may be configured so as to be able to set the addresses of the area in which the instruction RAM 121 will be placed. To be specific, as shown in FIG. 5, a start address setting register 122a and a memory size setting register 122b may be added to the location address setting section 122.

The start address setting register 122a is a register in which the start address of the area where the instruction RAM 121 will be placed is set.

The memory size setting register 122b is a register in which the capacity of the area where the instruction RAM 121 will be placed is set.

Then, in Step ST001, the location addresses, on the memory space, of the instruction RAM 121 can be set by performing the step of setting, in the start address setting register 122a, the start address of the area in which the instruction RAM 121 will be placed and the step of setting, in the memory size setting register 122b, the capacity of the area in which the instruction RAM 121 will be placed. That is, after the start address and the capacity are set, the instruction RAM 121 is placed on the memory space starting at the start address set in the start address setting register 122a and having the capacity set in the memory size setting register 122b.

According to this modified example, it is possible to easily set the area in which the instruction RAM 121 will be placed, by using the start address and the size of the memory to be placed.

In setting the area, the physical capacity of the instruction RAM 121 or the capacity of the instruction stream to be transferred to the instruction RAM 121 may be set in the memory size setting register 122b.

The physical capacity of the instruction RAM 121 is determined by the system specifications. Thus, in the case where the physical capacity of the instruction RAM 121 is set in the memory size setting register 122b, the value to be set can be obtained easily, which means that processes performed in the location address setting step is simplified. Also, in a case in which part of an instruction stream (that corresponds to the physical capacity of the instruction RAM 121) is transferred to the instruction RAM 121 for execution of that part, and the other part is executed on the main memory 110, the instruction stream can be executed seamlessly without considering addresses on the instruction RAM 121 and on the main memory 110, even if the instruction stream is larger than the physical capacity of the instruction RAM 121.

On the other hand, in the case where the capacity of the instruction stream to be transferred to the instruction RAM 121 is set in the memory size setting register 122b, the RAM space corresponding to the capacity of the instruction stream to be transferred can be set, and hence a more flexible program can be developed. For example, in a case in which only part of an instruction stream that is desired to be executed at high speed is executed on the instruction RAM 121, and the other part is executed on the main memory 110, the part to be transferred to the instruction RAM 121 can be selected flexibly. Furthermore, by setting the capacity of the part to be transferred to the instruction RAM 121 as the RAM space, the instruction stream can be executed seamlessly without considering addresses on the instruction RAM 121 and on the main memory 110.

### Second Embodiment

Next, a second embodiment of the present invention will be described.

In developing a program, in which an instruction stream stored in the instruction RAM 121 is executed from the instruction RAM 121 and the other instruction streams are executed from the main memory 110, the problem of address coincidences may occur in cases where the location address setting step (Step ST001) described in the first embodiment is performed. Specifically, in the location address setting method in which the location addresses of the instruction RAM 121 are set taking into account only coincidences of the addresses of instruction streams executed on the instruction RAM 121, the addresses of instruction streams executed on the instruction RAM 121 may coincide with the addresses of instruction streams executed on the main memory 110.

In view of this, in this embodiment, a location address setting section 122 is configured so that when an instruction stream that should be executed from the main memory 110 is executed, the location address setting section 122 sets, as the location addresses of the instruction RAM 121, addresses that are the same as those on the transfer source (the main memory 110) from which the instruction stream is transferred, as shown in Step ST201 in a flowchart in FIG. 6.

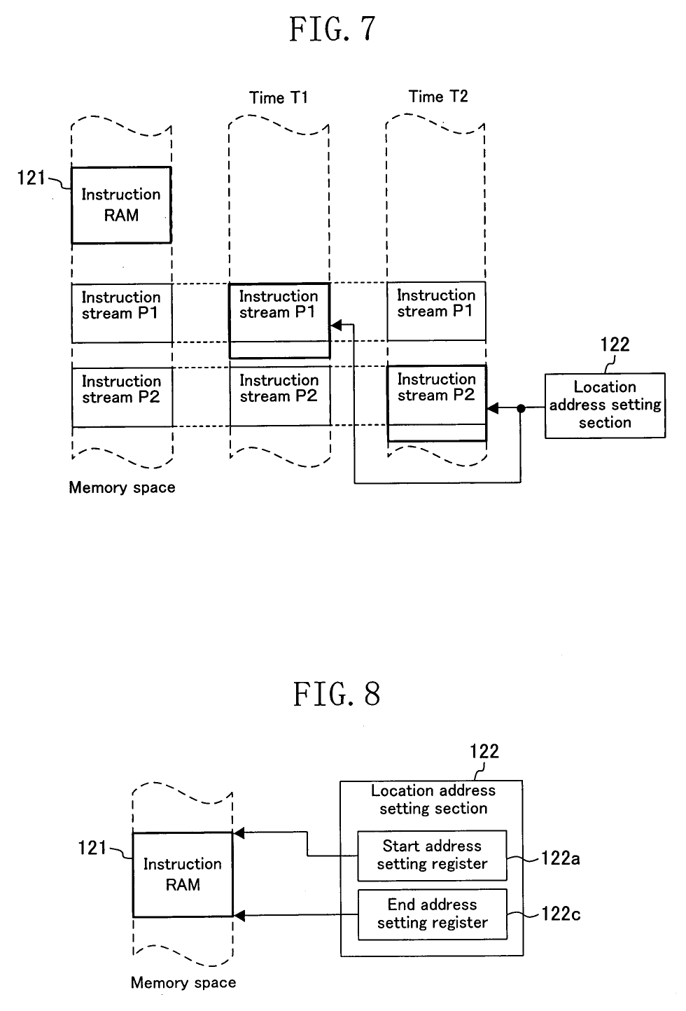

By setting the location addresses in this way, the addresses of the instruction streams executed on the instruction RAM 121 do not coincide with those of the instruction streams executed on the main memory 110, as shown in FIG. 7.

Moreover, the addresses on the main memory 110 are the only addresses for the instruction streams, permitting the program developer to develop the programs without taking overlay into account. Furthermore, since the programs can be executed without transferring all instruction streams to the instruction RAM, either the main memory or the instruction RAM can be flexibly selected as the memory for executing the programs, according to the execution frequency or the like.

### Modified Example of the Second Embodiment of the Present Invention

In the second embodiment, the location address setting section 122 may be configured so as to be able to set the addresses of the area in which the instruction RAM 121 will be placed. To be specific, as shown in FIG. 8, a start address setting register 122a and an end address setting register 122c may be added to the location address setting section 122.

The end address setting register 122c is a register in which the end address of the area where the instruction RAM 121 will be placed is set.

Then, in Step ST201, the location addresses on the memory space at which the instruction RAM 121 will be placed can be set by performing the step of setting, in the start address setting register 122a, the start address of the area where the instruction RAM 121 will be placed and the step of setting, in the end address setting register 122c, the end address of the area where the instruction RAM 121 will be placed. That is, after the start and end addresses are set, the instruction RAM 121 is placed on the memory space extending from the start address set in the start address setting register 122a to the end address set in the end address setting register 122c.

According to this modified example, it is possible to easily set the area in which the instruction RAM 121 will be placed, by using the start and end addresses.

In the location address setting step, a value obtained by adding the capacity of the instruction RAM 121 to the start address or a value obtained by adding, to the start address, the capacity of the instruction stream to be transferred to the instruction RAM 121 may be set in the end address setting register 122c.

The physical capacity of the instruction RAM 121 is determined by the system specifications. Thus, in the case where the value obtained by adding the capacity of the instruction RAM 121 to the start address is set in the end address setting register 122c, the value to be set can be obtained easily, and hence processes performed in the location address setting step is simplified. Also, in a case in which part of an instruction stream (that corresponds to the physical capacity of the instruction RAM 121) is transferred to the instruction RAM 121 for execution of that part, and the other part is executed on the main memory 110, the instruction stream can be executed seamlessly without considering addresses on the instruction RAM 121 and on the main memory 110, even if the instruction stream is larger than the physical capacity of the instruction RAM 121.

On the other hand, in the case where the value obtained by adding, to the start address, the capacity of the instruction stream to be transferred to the instruction RAM 121 is set in the end address setting register 122c, the RAM space corresponding to the capacity of the instruction stream to be transferred can be set, and hence a more flexible program can be developed. For example, in a case in which only part of an instruction stream that is desired to be executed at high speed is executed on the instruction RAM 121, and the other part is executed on the main memory 110, the part to be transferred to the instruction RAM 121 can be selected flexibly. Furthermore, by setting the capacity of the part to be transferred to the instruction RAM 121 as the RAM space, the instruction stream can be executed seamlessly without considering addresses on the instruction RAM 121 and on the main memory 110.

In the second embodiment and the modified example thereof, all instruction streams transferred to the instruction RAM do not have to be set at the same addresses as those on the main memory, and only an instruction stream or streams that are desired to be executed on both the main memory and the instruction RAM may be set at the same addresses.

### Third Embodiment

Next, a third embodiment of the present invention will be described.

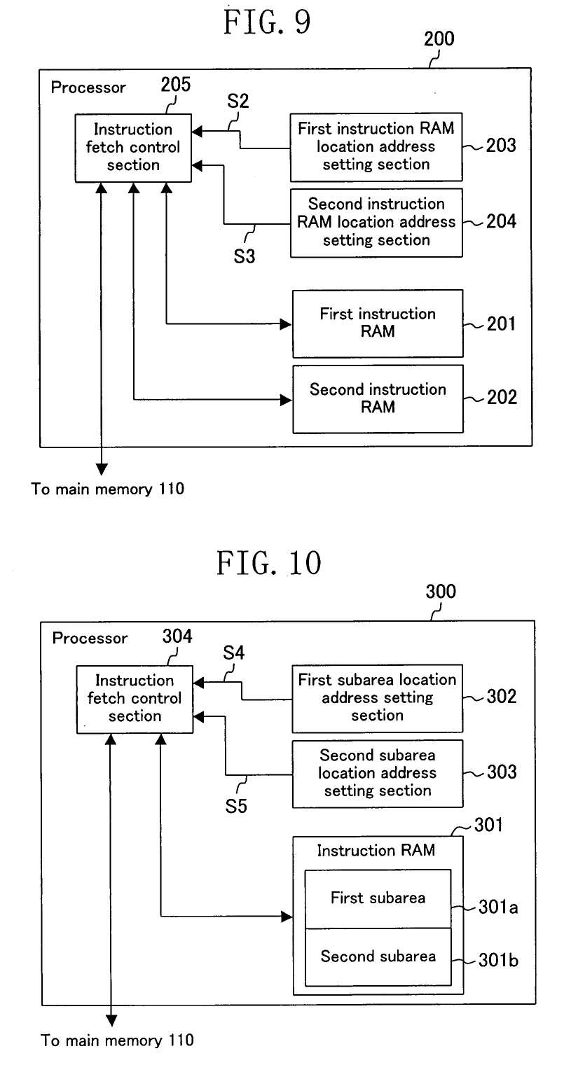

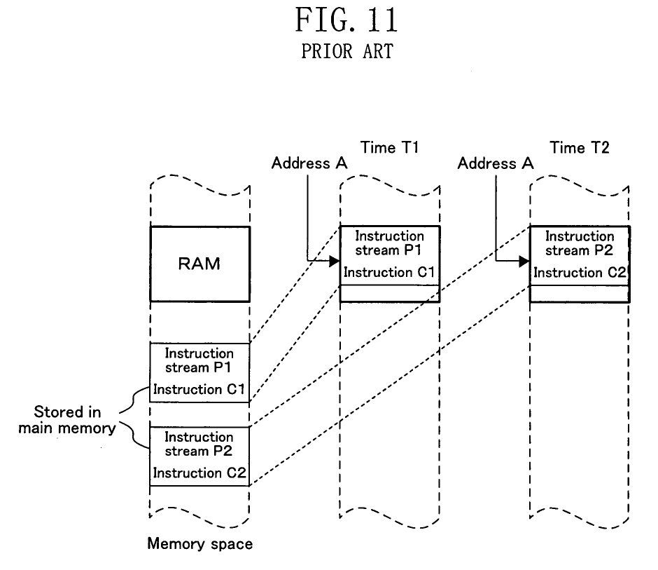

FIG. 9 is a block diagram schematically illustrating the configuration of a processor 200 according to this embodiment. As shown in FIG. 9, the processor 200 includes a first instruction RAM 201, a second instruction RAM 202, a first instruction RAM location address setting section 203, a second instruction RAM location address setting section 204, and an instruction fetch control section 205.

The first instruction RAM 201 and the second instruction RAM 202 store therein instruction streams transferred from a main memory 110.

The first instruction RAM location address setting section 203 sets location addresses on the memory space at which the first instruction RAM 201 will be placed.

The second instruction RAM location address setting section 204 sets location addresses on the memory space at which the second instruction RAM 202 will be placed.

Based on information (location address information S2) indicating the location addresses for the first instruction RAM 201 set in the first instruction RAM location address setting section 203, and on information (location address information S3) indicating the location addresses for the second instruction RAM 202 set in the second instruction RAM location address setting section 204, the instruction fetch control section 205 determines a space to be accessed by an instruction fetch access and makes access to the memory to be accessed (herein the first instruction RAM 201, the second instruction RAM 202, or the main memory 110).

By this configuration, a plurality of instruction streams can be simultaneously stored in the instruction RAMs (the first and second instruction RAMs 201 and 202) in the processor, which enables development of more flexible programs and more efficient program debugging.

The instruction RAMs may be used in such a manner that while an instruction is being executed on one of the instruction RAMs (either the first or second instruction RAM 201 or 202), an instruction stream is transferred to the other instruction RAM. When the instruction RAMs are used in this way, transfer-caused overhead can be reduced.

In this embodiment, the processor 200 includes the two instruction RAMs and the two location address setting sections. Nevertheless, the number of instruction RAMs and the number of location address setting sections are not limited to two, which is just an example. That is, an equal number of instruction RAMs and location address setting sections (i.e., n instruction RAMs and n location address setting sections) may be included.

### Modified Example of the Third Embodiment of the Present Invention

Alternatively, one instruction RAM may be provided and the memory area in the instruction RAM may be divided into a plurality of subareas, so that location addresses can be set for each subarea.

FIG. 10 is a block diagram illustrating the configuration of a processor 300 according to a modified example of the third embodiment of the present invention. As shown in FIG. 10, the processor 300 includes an instruction RAM 301, a first subarea location address setting section 302, a second subarea location address setting section 303, and an instruction fetch control section 304.

The instruction RAM 301 is divided into a plurality of subareas, namely a first subarea 301a and a second subarea 301b. These subareas each retain an instruction stream transferred from a main memory 110.

The first subarea location address setting section 302 and the second subarea location address setting section 303 output location address information for the first subarea 301a and the second subarea 301b, respectively. Specifically, the first subarea location address setting section 302 outputs, to the instruction fetch control section 304, information (location address information S4) indicating location addresses for the first subarea 301a, while the second subarea location address setting section 303 outputs, to the instruction fetch control section 304, information (location address information S5) indicating location addresses for the second subarea 301b.

Based on the location address information S4 and S5, the instruction fetch control section 304 determines a space to be accessed by an instruction fetch access and makes access to the memory to be accessed (herein the first subarea 301a, the second subarea 301b, or the main memory 110).

By configuring the processor 300 as shown in FIG. 10, a plurality of instruction streams can be simultaneously stored in the instruction RAM without increasing macro points in the instruction RAM. It is thus possible to develop flexible programs, while suppressing increases in hardware.

The transfer method employed in Steps ST002 and ST202 is not limited to the DMA transfer performed by the DMA controller 130. To be specific, the transfer may be performed by a higher-level processor or the like, for example.

The foregoing embodiments and the modified examples thereof, which allow a plurality of instruction streams executed on an instruction RAM or RAMs to be placed in such a manner that the addresses thereof do not coincide with each other, are applicable also to cases in which a compressed instruction stream is transferred while being expanded.

Furthermore, the components described in the foregoing embodiments and the modified examples thereof may be used in various combinations so long as those combinations are logically possible. For example, in the processor 200 of the third embodiment and in the processor 300 of the modified example of the third embodiment, the start address setting register 122a and the memory size setting register 122b (or the start address setting register 122a and the end address setting register 122c) may be provided in the location address setting section so that the area in which the instruction RAM will be placed can be set.

Also, it is obvious that various changes and modifications may be made in the invention without departing from the scope of the invention.

As described above, the data processing devices according to the present invention produce the effect that while increases in hardware are suppressed, program debugging can be performed by using a conventional debug device and debugger. The inventive data processing devices thus effectively function as data processing devices, etc., that includes a processor which transfers an instruction stream stored in a flash memory and the like to a RAM for execution of the instructions.

What is claimed is:

1. A data processing device comprising a main memory for storing therein a plurality of instruction streams and a processor for executing an instruction stream transferred from the main memory,
wherein the processor comprising:
an instruction RAM for storing therein the instruction stream transferred from the main memory;
a location address setting section for setting location addresses on a memory space at which the instruction RAM will be placed in such a manner that location addresses, on the memory space, of the instruction stream stored in the instruction RAM do not coincide with location addresses, on the instruction RAM, of another instruction stream; and
an instruction fetch control section for determining, based on location address information indicating the location addresses set by the location address setting section, a space to be accessed by an instruction fetch access, and, according to result of the determination, making access to either the main memory or the instruction RAM.

2. The data processing device of claim 1, wherein the location address setting section is configured so as to set, as the location addresses of the instruction RAM, addresses that are the same as addresses on the main memory from which the instruction stream is transferred.

3. The data processing device of claim 1, wherein the location address setting section includes a start address setting register, in which the start address of an area where the instruction RAM will be placed is set, and a memory size setting register in which the capacity of the area where the instruction RAM will be placed is set; and
the location address setting section is configured so as to set the location addresses, on the memory space, of the instruction RAM, in the area starting at the start address set in the start address setting register and having the capacity set in the memory size setting register.

4. The data processing device of claim 1, wherein the location address setting section includes a start address setting register, in which the start address of an area where the instruction RAM will be placed is set, and an end address setting register in which the end address of the area where the instruction RAM will be placed is set; and
the location address setting section is configured so as to set the location addresses, on the memory space, of the instruction RAM, in the area extending from the address set in the start address setting register to the address set in the end address setting register.

5. The data processing device of claim 3, wherein the location address setting section is configured so as to set the capacity of the instruction RAM, in the memory size setting register.

6. The data processing device of claim 3, wherein the location address setting section is configured so as to set the capacity of the instruction stream transferred to the instruction RAM, in the memory size setting register.

7. The data processing device of claim 4, wherein the location address setting section is configured so as to set, in the end address setting register, a value obtained by adding the capacity of the instruction RAM to the address set in the start address setting register.

8. The data processing device of claim 4, wherein the location address setting section is configured so as to set, in the end address setting register, a value obtained by adding the capacity of the instruction stream transferred to the instruction RAM to the address set in the start address setting register.

9. The data processing device of claim 1, wherein a plurality of said instruction RAMs are provided, and
the location address setting section is provided for each of the instruction RAMs in a one-to-one correspondence.

10. The data processing device of claim 1, wherein the instruction RAM is divided into at least two memory areas; and
the location address setting section is provided for each of the memory areas in a one-to-one correspondence.
